(19) United States
(12) Patent Application Publication
(10) Pub. No.: US 2012/0029996 A1
(43) Pub. Date: Feb. 2, 2012

(54) Loyalty-Based Credit Prescreening System

(75) Inventors: Daniel J. Lang, Grove City, OH (US); Katherine Anne Robinson, Dublin, OH (US); Carla Shroyer, Pataskala, OH (US)

(73) Assignee: Alliance Data Systems Corporation, Dallas, TX (US)

(21) Appl. No.: 12/847,775

(22) Filed: Jul. 30, 2010

(51) Int. Cl. G06Q 30/00; G06Q 40/00

(52) U.S. Cl. 705/14.27; 705/38

(57) ABSTRACT

An integrated credit and loyalty offering to a retailer maximizes the effectiveness of both programs. The integrated system allows a retailer to enroll customers in a loyalty program, then solicit only pre-qualified customers immediately upon receipt of demographic information corresponding to the customer. The integrated system accepts transaction data from the retailer's loyalty program through the retailer's POS system to the credit prescreening program and awards appropriate loyalty rewards, as well as authorizing the retailer to offer credit to the pre-qualified customers. The credit prescreening process is done in real time as part of a retail transaction with the customer.

### BACKGROUND OF THE INVENTION

1. Field of the Invention

The present invention relates to the field of loyalty programs, and in particular to a loyalty-based credit prescreening system.

2. Description of the Related Art

Many retailers use multiple methods at point of sale (POS) to capture customer information. One is a loyalty program, such as a multi-tender loyalty program; another is a credit program (private label or co-brand). Both tools take resources at the POS to solicit the product and process the application. The retailer must decide where to focus so that customer service is not compromised. While a loyalty program will attract a larger number of customers and provide a greater marketing reach, credit programs typically provide the retailer with a greater financial benefit through reduced merchant fees and marketing incentives.

Loyalty and credit each bring unique value to the retailer, and have historically been offered separately. Under the existing model, the retailer must decide where to focus resources so that customer service is not compromised. Further, because retailers dislike selling credit to customers who are then declined when trying to offer a credit account, retailers sometimes stop selling credit altogether.

### BRIEF SUMMARY OF THE INVENTION

In brief, a loyalty-based credit prescreening program allows a retailer to enroll customers in a loyalty program, then solicit only pre-qualified customers for financial instruments at the time of the transaction.

In one embodiment, a method comprises (a) receiving a first data corresponding to a customer from a retailer, the first data related to a loyalty account corresponding to the customer, (b) prescreening the customer for credit responsive to the first data; and (c) authorizing the retailer to offer credit to the customer, wherein (a), (b), and (c) are performed as part of a transaction between the customer and the retailer.

In another embodiment, a system comprises a first processor, a first storage subsystem, coupled to the first processor, configured to store: a credit prescreening software, which when executed causes the processor to perform actions comprising (a) receiving a first data corresponding to a customer from a retailer, the first data related to a loyalty account corresponding to the customer, (b) prescreening the customer for credit responsive to the first data; and (c) authorizing the retailer to offer credit to the customer, wherein (a), (b), and (c) are performed as part of a transaction between the customer and the retailer.

In another embodiment, a method of integrating credit and loyalty programs comprises accepting a transaction data from a retailer POS system for a transaction by a loyalty program member, awarding loyalty rewards to the member responsive to the transaction data, prescreening the member for a financial instrument as part of the transaction, and authorizing the retailer to offer the financial instrument to the member responsive to prescreening the member.

In another embodiment, an integrated credit and loyalty system for operating a loyalty program comprises a processor, a storage subsystem, coupled to the processor comprising storage media configured to store a database of loyalty program member information, a software program, which when executed causes the processor to perform actions comprising: enrolling a member in the loyalty program; updating the database of loyalty program member information responsive to a transaction by the member with a retailer; awarding loyalty rewards to the member responsive to the transaction; prescreening the member for a financial instrument; and authorizing the retailer to offer the financial instrument to the member.

### BRIEF DESCRIPTION OF THE SEVERAL VIEWS OF THE DRAWINGS

The accompanying drawings, which are incorporated in and constitute a part of this specification, illustrate an implementation of apparatus and methods consistent with the present invention and, together with the detailed description, serve to explain advantages and principles consistent with the invention. In the drawings,

FIG. 1 is a block diagram illustrating the relationships between a retailer and various other systems according to one embodiment;

FIG. 2 is a high-level block diagram illustrating one embodiment of an integrated credit and loyalty system;

FIG. 3 is a block diagram of the credit prescreening technique according to one embodiment;

FIG. 4 is a block diagram illustrating a simplified computer system for performing the credit prescreening technique according to one embodiment;

FIG. 5 is a block diagram illustrating a multi-tender loyalty program according to one embodiment; and

FIGS. 6A and 6B are a process flow chart illustrating an integrated credit prescreening and loyalty system according to one embodiment.

### DETAILED DESCRIPTION OF THE INVENTION

A loyalty-based credit prescreening program allows retailers to integrate credit and loyalty offerings to maximize joint benefit. Such a system allows retailers to “lead with loyalty” and up sell to credit. As discussed herein, a “loyalty program” is a database or other system accessible in real time by a retailer point of sale (POS) system that contains customer demographic information. In some, but not all, loyalty programs, a group of parameters and rules govern the application of a reward, typically expressed as points or other similar units, to members for purchases or other non-monetary related activity, together with the computer systems that implement those parameters and rules. A “multi-tender loyalty program” is a loyalty program where a member can earn loyalty rewards for any type of tender used in a transaction, including the use of multiple tender types in a single transaction. A member enrolls in a loyalty program by providing demographic information, such as name, address, etc., and receives a membership or account number or other account identification information for the loyalty program. In some loyalty programs, retailers offer use a “take-one” technique for collecting members, which refers to the retailer having a number of membership cards or materials in the store that can be provided to the member upon request or left in an area for the member to take one at will.

There are synergies to be had in using loyalty as a credit catalyst; namely, lessening the resources required of the retailer at POS to solicit the product(s) and process the application. Under the conventional model, the retailer must decide where to focus resources so that customer service is not compromised. In an integrated credit and loyalty system, retailers can lead with loyalty, then once loyalty customers have been established, retailers can separately offer customers credit. An integrated system simplifies the customer experience at the POS, avoiding or lessening the need for multiple product pitches. In addition, no customer will ever be declined access to either loyalty or credit, because loyalty is available to all, and only qualified customers will be solicited for credit.

Retailers using an integrated credit and loyalty program can collect customer demographics on behalf of their loyalty program (either at the POS, via take-one, web registration/enrollment or call-in registration/enrollment. Using this demographic data, retailers can pre-qualify their customer base for a credit program. Using this data, only qualified customers are solicited with an offer for a credit product. The system allows for retail prescreen which will allow the credit offer to qualified customers immediately upon receipt of demographics received for the loyalty program. Qualification data can be used to solicit customers for credit products through a variety of mediums, including at Retail POS. The credit offering can be made as pat of a transaction by the customer with the retailer. The integrated credit and loyalty program in some embodiments offers a low-cost multi-tender loyalty program to retailers who cannot afford a fully integrated CRM solution. Multi-tender customer profiles can be compiled for use in driving incentive strategies through rebates and certificates. In other embodiments, a retailer's existing loyalty program can be used to provide the demographic data for the prescreening.

Combining loyalty and credit into a single turnkey offering can alleviate the retailer burden of supporting multiple methods at point of sale to capture customer information. This burden often comes at the expense of the customer, but it can also be resource intensive to the retailer. An integrated system as disclosed herein simplifies the product to the customer and to the service representative, while increasing the efficiency with which offers are made. On the other hand, for retailers who have an existing loyalty program, adding a credit prescreening system can provide similar benefits. As disclosed herein, an integrated credit and loyalty system can be implemented as a single turnkey system from a single service provider, or as separate systems where the loyalty program can be provided by an third party or even by the retailer itself. The integration allows providing demographic data from the loyalty program to the credit prescreening system for use in the prescreening.

As stated above, one target market for an integrated credit and loyalty system is the retailer who, for whatever reason, cannot justify the expense of a larger program. One potential advantage to such a retailer is the program's utility in driving credit program adoption. Other retailer benefits of this integrated approach include maximized access to a wider customer base, ability to focus training efforts on a single process in order to maximize loyalty acquisition, a prescreen process that makes the credit offer a much more positive experience for both the store associate and the customer since only those who are pre-approved are solicited, decreased costs for POS changes, consolidated vendor management (in single provider embodiments, where there is no third party loyalty provider to manage), stronger branding and brand affinity, integrated communication strategies, integrated customer segmentation and resulting marketing strategies and enhanced private label credit card and co-brand value propositions. For embodiments where the retailer uses an integrated POS and a single provider integrated system, development costs that would be separately incurred in the past are now a single project, since loyalty and credit applications are integrated and in some embodiments can be sent to the credit and loyalty program provider through the same connection. Customers also experience benefits from this approach: shorter application times during checkout, minimized risk of dealing with a declined credit application, and more chances to earn rewards.

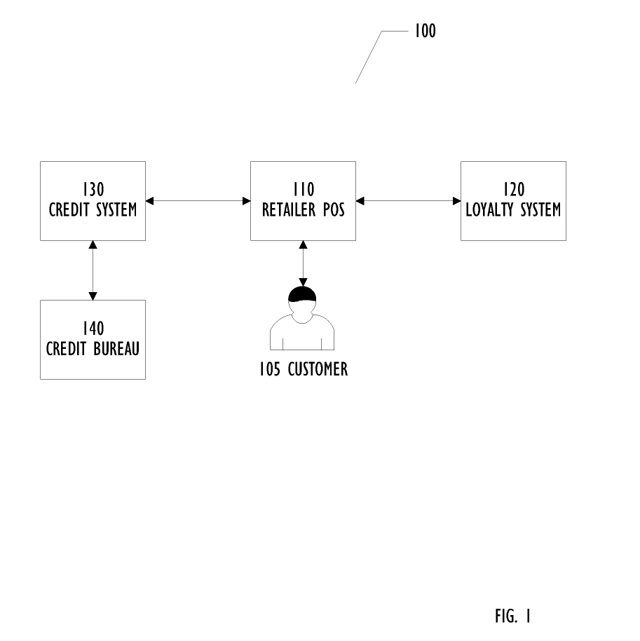

FIG. 1 is a block diagram illustrating the relationship between the retailer and the various other systems in an integrated credit and loyalty system 100. The retailer interacts with customer 105 through the retailer POS system 110. The retailer POS system 110 is in communication with loyalty system 120. Any desirable communication technique can be used for this communication, including TCP/IP over the Internet, possibly involving intermediary systems, not shown in FIG. 1 for clarity.

Similarly the retailer POS communicates with credit system 130, which performs the credit prescreening. As with the loyalty system 120, the retailer POS 110 and credit system 130 can use any desirable communication technique. No direct communication is required between the credit system 130 and the loyalty system 120. The credit system 130 communicates with the credit bureau 140 or other similar source of credit rating information. Although only a single credit bureau 140 is shown in FIG. 1, the credit system can be configured to request credit rating data from a plurality of credit rating data sources 140, which may be credit bureaus or other sources of such information known to the art. In embodiments where credit rating data is obtained from a plurality of credit rating data sources, any desired technique for combing a returned credit rating data can be used. The retailer POS 110 does not need to have a direct link to the credit rating source 140.

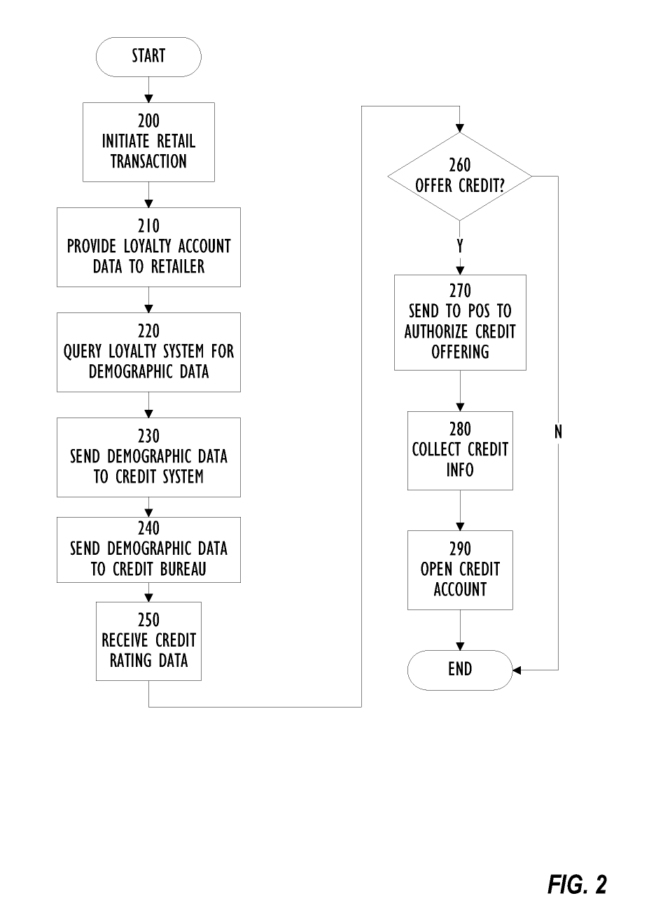

FIG. 2 is a high-level flow chart illustrating the basic steps of one embodiment of an integrated credit and loyalty system 100. In block 200, the customer 105 initiates a transaction at a retail establishment, typically by approaching a register with goods to purchase. As part of the transaction, the retailer accepts from the customer in block 210 information identifying the customer 105 as a member of the retailer's loyalty program 120. In some embodiments, this is done by the customer 105 or the retailer swiping a card through a card reader to provide loyalty membership account data. In other embodiments, the customer 105 may provide a key fob or other item that is bar coded or otherwise marked with account data that can be read by the retailer's POS system 110. These techniques are exemplary and illustrative only and other techniques can be used. In block 220, the retailer POS 110 sends the loyalty account identification over a communications network to the loyalty program system 120, requesting demographic data for the customer 105. In block 230, the retailer sends the demographic data received from its loyalty system 120 from the retailer POS 110 to the credit prescreening system 130 over a communications network, which may be the same or a different network as that used for communicating with the loyalty system 120. In some embodiments, the loyalty program system 120 can be provided by the provider of the credit prescreening system. In such embodiments, the loyalty system 120 can communicate directly with the credit prescreening system 130, instead of using the retailer POS 110 as an intermediary.

The credit system 130 then, in block 240, sends at least some of the demographic data, in particular name and address information, to a credit rating resource 140, such as a credit bureau, asking for a credit score or other credit information corresponding to the customer 105. Upon receipt in block 250 of the credit rating data, the credit system 130 in block 260 prescreens the customer 105 based on the credit rating data and to decide whether to authorize the retailer to offer credit to the customer 105. The credit system 130 in block 270 sends the authorization to the retailer POS 110. The retailer can then in block 280 offer credit to the customer 105 and collect any other necessary information from the customer 105 for opening a credit account and issuing a financial instrument such as a credit card. Finally, in block 290, the credit system 130 can take the customer information and open a new credit account for the customer 105, which can be used to pay for the transaction. Generally, a financial instrument, such as a credit card, is then mailed or otherwise delivered to the customer 105. In some embodiments, information about the credit account can be printed on a receipt for the transaction for use until the delivery of the financial instrument. All of these activities take place while the customer 105 is still at the register, as part of the retail transaction.

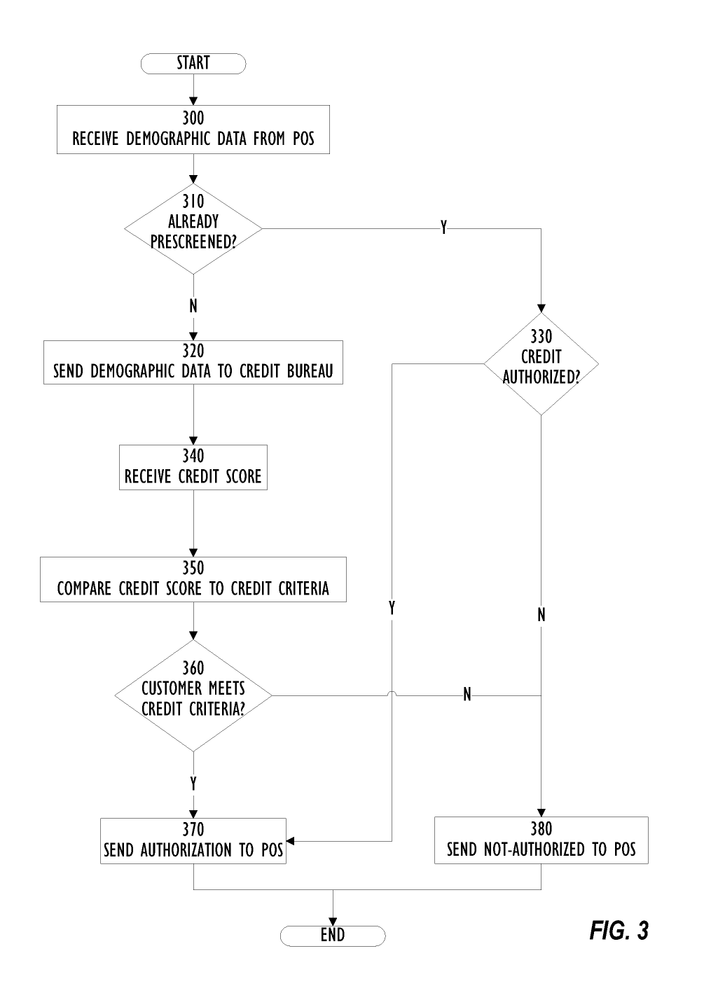

FIG. 3 is a block diagram of the credit prescreening technique according to one embodiment in more detail. In block 300, corresponding to block 230 of FIG. 2, the credit prescreening system 130 receives demographic data from the retailer POS 110. In embodiments where the loyalty system 120 communicates directly with the credit system 130, this demographic data can be received directly from the loyalty system, without passing through the POS 110. Then in block 310, the credit system 130 looks up the customer 105 in a data base of previously prescreened customers. If the customer 105 has been prescreened and the prescreening is still valid, then no prescreening is necessary, but the results of the previous prescreening can be used. Any desirable criterion can be used to decide whether a previous prescreening is valid. In one embodiment, the previous prescreening is considered valid for 180 days. The previous prescreening may have been made as a result of a previous transaction by the customer 105 with the current retailer or another retailer. In some embodiments, the customer 105 may have been prescreened as part of a batch prescreening, such as when the credit system 130 has bought a list of customer information and prescreened the list.

If the customer 105 currently has credit account, then no credit offer is required. If the customer 105 does not already have a credit account, if the customer 105 matches existing prescreen information, then in block 330 the credit system 130 determines whether the prescreening authorized the issuance of credit to the customer 105. If a credit offering is authorized, then the system sends an authorization back to the retailer POS 110 in block 370. If a credit offering is not authorized, then the system sends a not-authorized data to the retailer POS 110 in block 380. In some embodiments, block 380 is not performed and only data indicating an authorization to offer credit are sent to the retailer POS 110. The retailer will then offer credit only if authorized by the credit system 130.

If the customer 105 has not previously been prescreened, or the prescreening is no longer valid, then in block 320 the credit system begins a new real time prescreening by sending demographic information to a credit bureau or other source of credit rating data 140. Typically, a credit bureau 140 will report back a credit score or other similar rating data, with other possible information as requested in block 320.

In block 340, the credit system 130 receives the credit rating data. In block 350 the credit system 130 compares the credit rating data to selected credit rating criteria. For example, if the credit bureau 140 returns a numeric credit score value, the credit system 130 may compare the returned credit rating to a credit score threshold value. In block 360, if the customer credit score is less than the selected threshold value (assuming a higher score is a better score than a lower score), then the customer 105 fails the prescreening; if the customer 105's score exceeds the threshold value, the customer 105 qualifies for credit. The use of a credit score value and threshold valuers exemplary and illustrative only, and any desired or available credit rating data can be used and evaluated noting any desirable criteria.

Then in blocks 370 and 380, as explained above, the credit system 130 notifies the retailer POS 110 of the prescreening decision. If the customer 105 qualifies for credit, then the retailer may offer the customer 105 credit as described above in the discussion of FIG. 2.

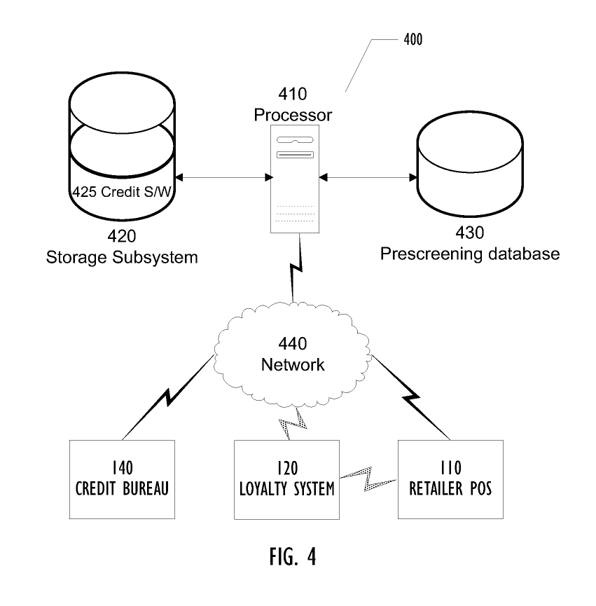

Turning now to FIG. 4, a block diagram illustrates a simplified computer system 400 corresponding to the credit system 130 of FIG. 1 for performing the credit prescreening technique. Common computer devices not specifically relevant to the discussion are omitted from FIG. 4 for clarity of the drawing. The loyalty system 120, although not necessarily a part of computer system 400 corresponding to the credit prescreening system 130, is shown here for clarity, with alternate connections to either to the retailer POS 110 (such as embodiments where the loyalty system 120 is a third party system) or the computer system 400 corresponding to the credit system 130 (such as embodiments where both the credit system 130 and the loyalty system 120 are provided by the same entity). A processor 410 executes one or more software programs 425 stored in a storage subsystem 420 to perform the actions described above for FIG. 1. The storage subsystem 420 can be implemented in any way known to the art as desired. A prescreening data base 430 can be used to store previous prescreening information, as well as any criteria or other data used by the prescreening software 425. Although shown for clarity as two separate storage subsystems in FIG. 4, the arrangement of storage on physical media is not significant for purposes of this technique and a combined or further split storage system can be used as desired.

The processor 410 is connected to a network 440, such as the Internet, and thence to the retailer POS 110 using any desired communication equipment and software. Alternatively, the processor 410 can use the public switched telephone network, or any other desired communication technique to communicate with the retailer POS 110 and credit bureaus 140.

In some embodiments, the retailer POS system 110 must be modified to handle the interface with the credit screening system 400. The changes necessary would be to modify the POS system 110 using transactions to send to demographic data from the POS system 110 to the credit prescreening system 400 and to accept information about pre-approval for credit. In some embodiments, a standard protocol, for example the ISO-8583 protocol, is used for those transactions. In some embodiments, the modified POS system 110 would display the pre-approval for credit as a screen or other display at the retailer POS 110, triggering the retailer to offer credit to the customer 105. In other embodiments, a credit offer can be printed on the receipt or other paper provided to the customer 105, with instructions on how to apply for credit.

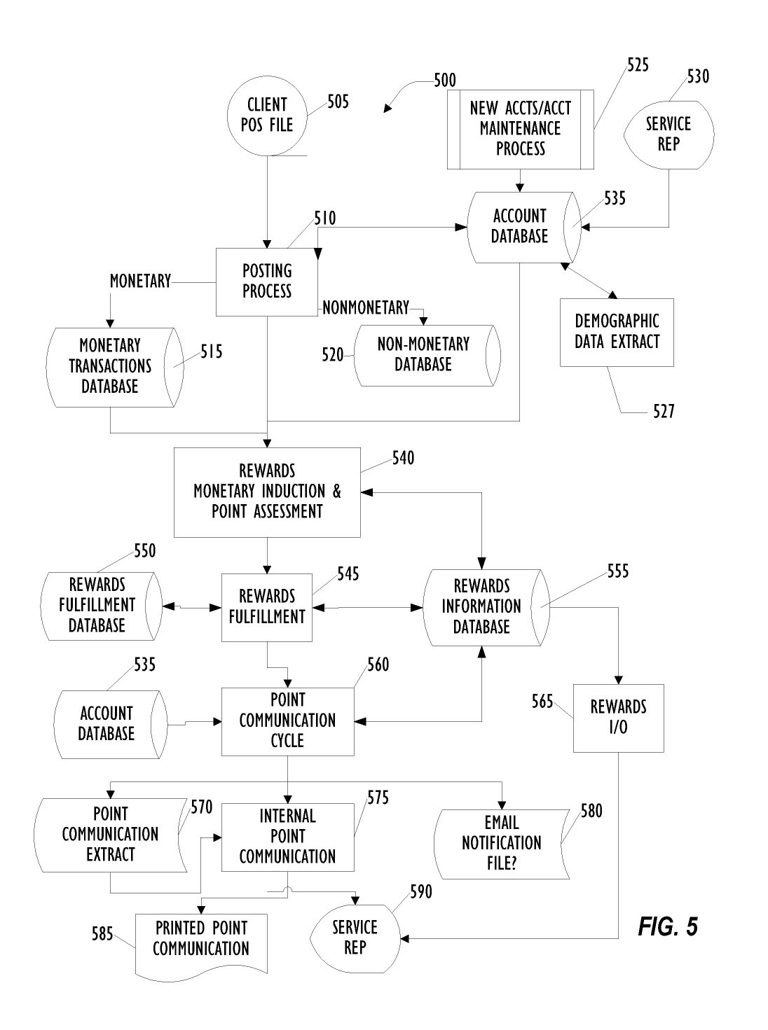

Although as generally illustrated in FIGS. 1-4 the credit prescreening system 130 can be provided by a different service provider from the service provider of the loyalty system 120, as described above, a service provider can offer both credit and loyalty systems, to further integrate both systems. FIG. 5 is a block diagram illustrating one embodiment of a loyalty program 120, in particular a multi-tender loyalty program.

Turning to FIG. 5, a loyalty system 500 corresponding to the loyalty program 120 of FIG. 1 involves a number of database tables and processes. Client POS data 505 is received, typically as a batch file, from the retailer POS 110. A posting process 510 then posts the client POS data to databases 515 (monitoring-transactions) and 520 (non-monetary transactions). A process 525 allows new accounts to be created, as well as processes for allowing members to update their information, such as, but not limited to, interaction with a web page offering account information update capabilities. In addition, service representative screens 530 of the integrated credit and loyalty system provider can update member information in the member account information database 535, responding to, for example, member telephone calls or other member communications. A data extract process 527 can be used for communication with the retailer 450 for the data needed for the credit prescreening.

After the posting process 510 completes, a rewards monetary induction and print assessment process 545 uses the results of the posting process 510 to update the monetary-transaction database tables 515, and the member account database tables 535 to determine what reward points should accrue to the member based on the transaction, if any.

In some embodiments, rewards points can be awarded responsive to the amount of the transaction or the individual items in the transactions. In other embodiments, the rewards points awarded may also depend on the specific item in the transaction, with only some items earning rewards points, or with some items earning more points then other items of equal price. The assignment of awards points is defined by business rules established by the retailer together with program provider. Although the present disclosure refers to “rewards points,” the terminology and value, if any of the rewards units can vary. Airlines, for example, typically refer to rewards points as miles, while other retailers may use simply points or even currency-denominated unit values.

As with conventional loyalty programs, members not only earn rewards, they can spend or redeem those rewards points. In block 540, a rewards fulfillment process can determine what rewards are to be delivered to the member, based on rewards information database tables 555, tracking fulfillment activity in rewards fulfillment database tables 550. The actual rewards fulfillment process is a conventional loyalty program process and is not otherwise described herein. In block 560, a loyalty rewards point communication cycle generates reports and other communications for sending to members, loyalty program clients, and internally through the program provider. Point communication cycle 560 retrieves rewards data from the rewards information database 555, as well as from member account database tables 535 (shown duplicated herein FIG. 5 for clarity of the drawing only). The cycle 560 will also update information in the databases, rolling balances and inserting point communication history information. As a result of the loyalty reward point communications cycle process 560, print communication extracts 580 are created and used by internal point communication processes. E-mails can also be created to notify members and others of reward point value changes and other useful information in block 580. The process 575 can generate printed point communications 585, such as statements mailed to members, and update screens 590 for service representatives, using rewards I/O module 565 to update the screens 590.

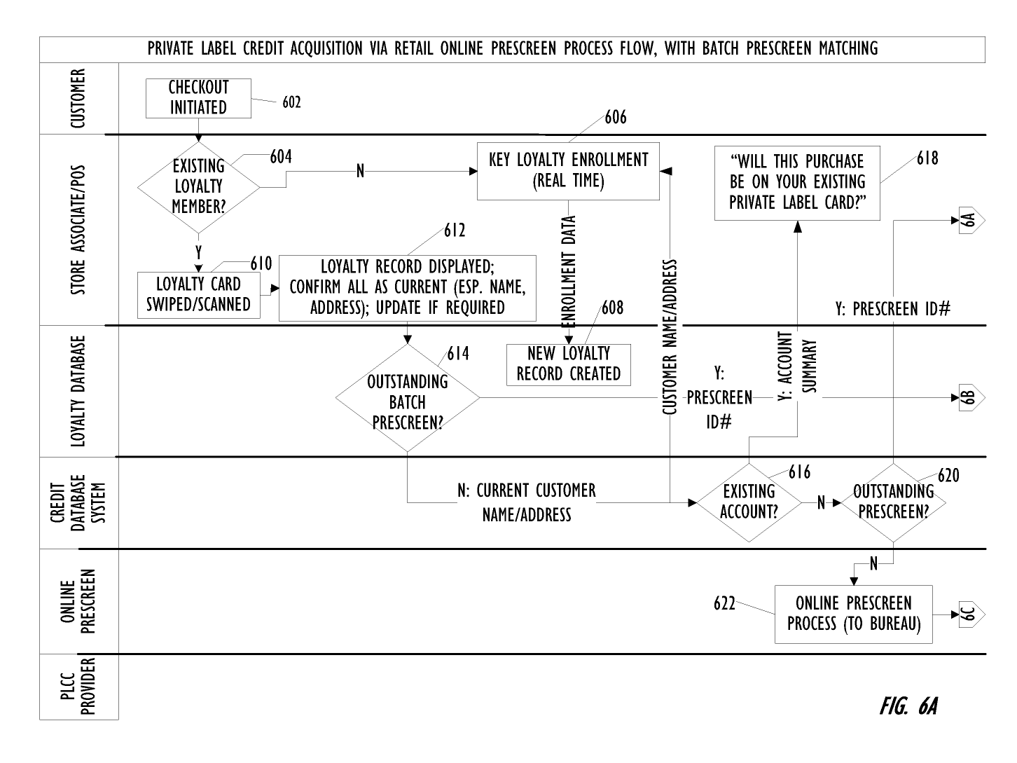

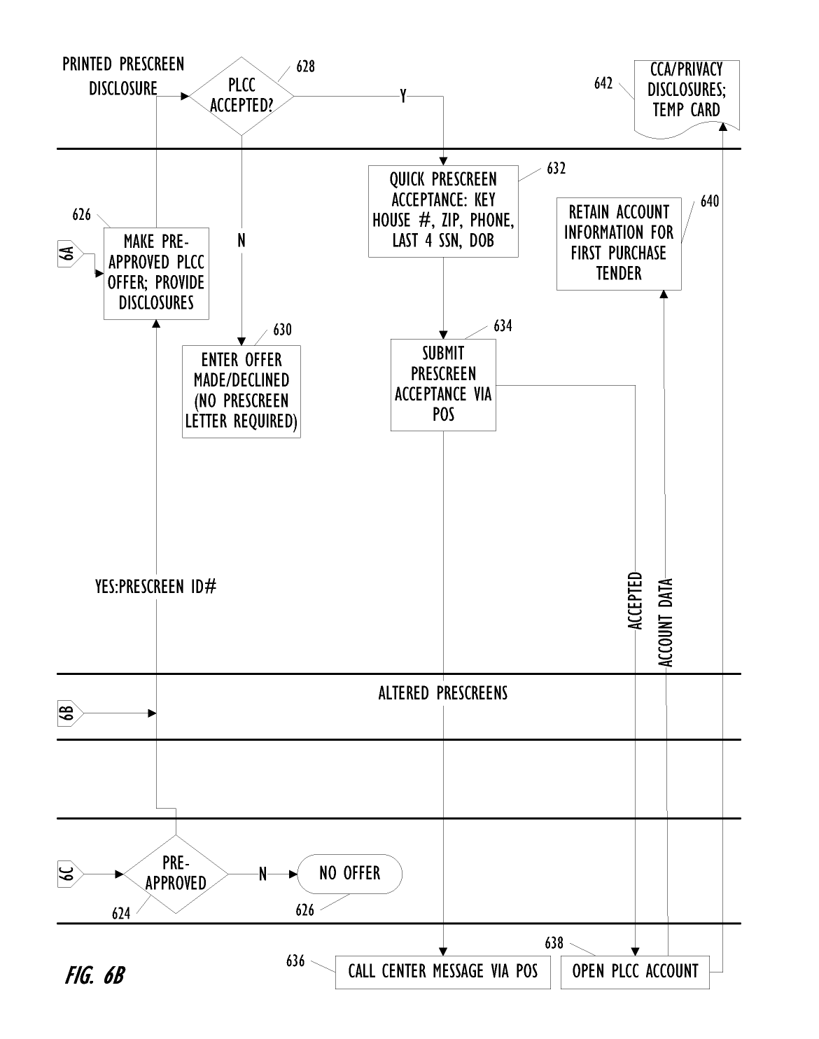

FIGS. 6A and 6B are a process flow chart illustrating one embodiment of an integrated credit prescreening and loyalty system, showing what entity performs what actions. As described above, the customer 105 initiates the transaction in block 602 by bringing the goods to be purchased to the retailer POS 110, or a register that is connected to or a part of the retailer POS 110. The store associate at the POS 110 then determines in block 604 whether the customer 105 is an existing loyalty member, typically by asking if the customer 105 has his or her loyalty card or other loyalty identification token. If the customer 105 indicates that the customer 105 is not a loyalty member, then the store associate can offer loyalty membership to the customer 105. If the customer 105 accepts, the store associate in block 606 can request and enter key loyalty information in real time into the POS 110 to enroll the customer 105.

Then the enrollment data is transmitted to the loyalty system 120, and a new loyalty record is created for the customer 105 in block 608. In addition, the POS 110 sends the customer 105 demographic information, typically name and address information to the credit prescreening system 130.

If the customer 105 is an existing loyalty member, then in block 610 the store associate or the customer 105 can swipe or scan the loyalty membership token or card to obtain loyalty account information, and display the loyalty record for the customer 105 in block 612, allowing the store associate to confirm and update, if necessary, the customer 105's information. If the loyalty record should be updated, the updated information is sent to the loyalty system 120.

In some embodiments, the retailer 110 can request a batch prescreening of an existing loyalty database. Every existing member of the loyalty database for the loyalty system 120 can be prescreened and the prescreening information stored in the loyalty database. In such embodiments, the loyalty system 120 can, in block 614 determine whether the prescreening is still valid and if so, whether the customer 105 is already authorized to be offered credit as a result of the batch prescreening. If the customer has pre-qualified for credit as a result of the batch prescreening, then the loyalty system 120 can provide a prescreening identification or authorization code to the POS 110. In embodiments in which the loyalty system 120 is provided by the same entity as the credit system 130, the loyalty system can interact directly with the credit system 130, instead of using the POS 110 as an intermediary as shown in FIGS. 6A and 6B.

If the loyalty system 120 does not hold an outstanding batch prescreen for the customer 105, then the customer name and address or other desired demographic information can be provided to the credit prescreening system 130. In some embodiments, a credit database subsystem first checks the customer 105 against existing credit account holders in block 616. If the customer 105 already holds a credit account, the credit database subsystem sends account information to the POS 110, so the store associate in block 618 can inquire if the customer 105 wants to pay for the purchase using his or her existing private label or co-branded credit card account.

If the customer 105 is not a current credit account holder, then in block 620, the credit database system determines whether an outstanding prescreen exists for the customer 105, as described above and in FIG. 3. If a previous prescreen remains valid for customer 105, then the prescreen identification or authorization code can be sent to the POS system 110.

If no valid prescreen is outstanding for the customer 105, then the real-time online prescreening process described above and in FIG. 3 can be performed to prescreen customer 105 with one or more credit bureaus 140 in block 622.

Turning to FIG. 6B, in block 624 the results of the prescreening are used to decide whether the customer 105 is pre-approved for credit. If not, then in block 626 no offer of credit is made.

If the customer 105 is pre-approved for credit, either from a previous batch prescreen, a previous real-time prescreen, or the current real-time prescreen, then a prescreen identification or authorization code is sent to the POS 110. The store associate can then in block 626 offer credit to the customer 105, offering a private label or co-branded credit account, providing any disclosures to the customer required by statute, regulation, or policy, typically in printed form. The customer 105 then in block 628 decides whether to accept the credit account.

If the customer rejects the credit offer, then the store associate can indicate to the POS 110 in block 630 that the customer 105 rejected the offer. The POS 110 can then pass that information on to the loyalty system 120, the credit prescreening system 130, or both. In that event, no letter or further communications with the customer 105 regarding a credit account are required. In some embodiments, the rejection is stored so that if the customer 105 makes a future transaction, the prescreening and credit offer is not repeated. In other embodiments, the credit offer can be made in future transactions.

If the customer 105 accepts the credit offer, then in block 632 the store associate can obtain any necessary information required to open the credit account, typically a street address, ZIP code, date of birth, and at least the last 4 digits of the customer 105's Social Security number. Then in block 634 the POS 110 can send the prescreen acceptance to the private label or co-branded credit card issuer. If the demographic data of the prescreen acceptance differs from the demographic data used for the original prescreen, then the altered prescreen data can be updated by the call center upon receipt of the prescreen acceptance data. For example, if the customer 105 has changed his or her address since the prescreening data was collected, personnel in the call center can update the demographic data appropriately. Additionally, in block 636, the call center can message the POS to prompt the store associate to correct data variances, such as when a Social Security Number was entered incorrectly, to allow the account to be opened. Then in block 638, the credit issuer opens a private label or co-branded credit account for the customer 105. Account information is returned to the POS 110 to allow the POS 110 to use the new credit account as tender for at least a portion of the transaction. Finally, in block 642 the credit issuer sends the usual printed documents to the customer 105, typically by mail, with privacy statements and other legally required information, as well as the actual financial instrument, such as a credit card.

As shown in FIGS. 6A and 6B, the loyalty system 120 is not necessarily operated by the credit prescreening system 130 and the credit issuing entity. But when those systems are all operated by the same entity, additional integration advantages will be apparent to the person of ordinary skill in the art. For example, as described above, the loyalty system 120 and credit prescreening system 130 can be integrated into a single system in some embodiments, or in other embodiments can interact directly with each other, using the retailer POS 110 less as an intermediary between the two systems.

The processes, steps, and ordering of steps in the above are exemplary and illustrative only and other processes, databases, tables, reports, etc. and other ordering of processes and steps can be used as desired.

While certain exemplary embodiments have been described in details and shown in the accompanying drawings, it is to be understood that such embodiments are merely illustrative of and not devised without departing from the basic scope thereof, which is determined by the claims that follow.

We claim:

1. A method, comprising:
(a) receiving a first data corresponding to a customer from a retailer, the first data related to a loyalty account corresponding to the customer;
(b) prescreening the customer for credit responsive to the first data; and
(c) authorizing the retailer to offer credit to the customer,
wherein (a), (b), and (c) are performed as part of a transaction between the customer and the retailer.

2. The method of claim 1, prescreening comprising:
sending a credit rating request including the first data to a source of credit rating information; and
receiving a credit rating data from the source of credit rating information.

3. The method of claim 1, authorizing the retailer to offer credit to the customer comprising:
obtaining a credit rating data from a source of credit rating information corresponding to the first data;
generating a credit decision responsive to the credit rating data; and
sending an authorization data to the retailer indicating whether the customer can be offered credit responsive to the credit decision.

4. The method of claim 1,
wherein the customer is a member of a loyalty system associated with the retailer, and
wherein the first data is a loyalty account data corresponding to the customer.

5. The method of claim 1, wherein the first data comprises the customer's name and address.

6. The method of claim 1, prescreening the customer for credit responsive to the first data comprising:
obtaining a credit rating data from a credit rating data source corresponding to the customer; and
generating a credit authorization decision responsive to the credit rating data.

7. The method of claim 1, further comprising:
(d) receiving a loyalty account data corresponding to the customer from the retailer by a loyalty system associated with the retailer; and
(e) sending the first data corresponding to the loyalty account data from the loyalty system to the retailer.

8. The method of claim 7, wherein the loyalty system is a multi-tender loyalty system.

9. The method of claim 1, further comprising:
receiving a credit application for the customer from the retailer;
creating a credit account for the customer.

10. The method of claim 1, wherein the first data is not supplied by the customer as part of the transaction.

11. The method of claim 1, further comprising:
establishing a loyalty account for the customer as part of the transaction with the retailer, comprising:
receiving the first data from the retailer; and
creating a loyalty account corresponding to the first data.

12. The method of claim 1, further comprising:
providing the retailer with a specification for changes to the retailer's POS system in a standardized format, the changes related to (a) and (c).

13. A system, comprising:
a first processor;
a first storage subsystem, coupled to the first processor, configured to store:
a credit prescreening software, which when executed causes the processor to perform actions comprising:
(a) receiving a first data corresponding to a customer from a retailer, the first data related to a loyalty account corresponding to the customer;
(b) prescreening the customer for credit responsive to the first data; and
(c) authorizing the retailer to offer credit to the customer,
wherein (a), (b), and (c) are performed as part of a transaction between the customer and the retailer.

14. The system of claim 13, prescreening comprising:
sending a credit rating request including the first data to a source of credit rating information; and
receiving a credit rating data from the source of credit rating information.

15. The system of claim 13, authorizing the retailer to offer credit to the customer comprising:
obtaining a credit rating data from a source of credit rating information corresponding to the first data;
generating a credit decision responsive to the credit rating data; and
sending an authorization data to the retailer indicating whether the customer can be offered credit responsive to the credit decision.

16. The system of claim 13,
wherein the customer is a member of a loyalty system associated with the retailer, and
wherein the first data is a loyalty account data corresponding to the customer.

17. The system of claim 13, wherein the first data comprises the customer's name and address.

18. The system of claim 13, prescreening the customer for credit responsive to the first data comprising:
obtaining a credit rating data from a credit rating data source corresponding to the customer; and
generating a credit authorization decision responsive to the credit rating data.

19. The system of claim 13, further comprising:
a second processor;
a second storage subsystem, coupled to the second processor, comprising storage media configured to store:
a loyalty software, which when executed causes the processor to perform actions comprising:
receiving a loyalty account data corresponding to the customer from the retailer by a loyalty system associated with the retailer; and
sending the first data corresponding to the loyalty account data from the loyalty system to the retailer.

20. The system of claim 19, wherein the loyalty software is a multi-tender loyalty software.

21. The system of claim 13, wherein the loyalty software when executed causes the processor to perform further actions comprising:
establishing a loyalty account for the customer as part of the transaction with the retailer, comprising:
receiving the first data from the retailer; and
creating a loyalty account corresponding to the first data.

22. The system of claim 13, the first storage subsystem further configured to store a credit application software that when executed causes the first processor to perform actions comprising:
receiving a credit application for the customer from the retailer; and
creating a credit account for the customer.

23. The system of claim 13, wherein the first data is not supplied by the customer as part of the transaction.

24. The system of claim 13, further comprising:
a specification for changes to the retailer's POS system related to (a) and (c).
